(19) United States
(12) Patent Application Publication
(10) Pub. No.: US 2016/0239492 A1
(43) Pub. Date: Aug. 18, 2016

(54) Process for Extracting Information from a Set of Data

(71) Applicant: Olivier Rocca, Vallauris (FR)

(72) Inventor: Olivier Rocca, Vallauris (FR)

(21) Appl. No.: 14/622,228

(22) Filed: Feb. 13, 2015

(51) Int. Cl. G06F 17/30

(52) U.S. Cl. CPC G06F 17/3053

(57) ABSTRACT

A method of extraction of information corresponding to one candidate data object among a plurality of candidate data objects contained in at least one database, and from parameters provided by evaluators, the method being executed by at least one processor and comprising the following steps:
a) Retrieving the plurality of candidate data objects from the at least one database;
b) Determining a set of ranks each having a different preference level on a preference scale;
c) Determining, for each evaluator, a candidate rank assigned to each of the retrieved candidate data objects;
d) For each candidate data object and each rank, processing a number of supports;
e) Extracting said information and generating at least one output comprising said information.

### TECHNICAL FIELD

The present invention relates notably to information and databases. More precisely, and without any limitation, the present invention relates to a process to extract information from a database.

### BACKGROUND

Information is one of the most important values in this new century. More and more data are collected every day about anything, about people as well as about automatic systems. One goal is to be able to optimize these systems using these data as well as being able to satisfy as much as possible people who are most of the time customers of a service, said service collecting data about its customers.

Nowadays, there are more and more data extracted from more and more sources from a very wide horizon. Companies as well as governments have to handle these data contained in bigger and bigger data storage in so many databases.

It is becoming a new challenge to be able to manage all these data. A lot of solutions have been proposed to organize, order and process all these data. But there is no real solution for extracting a real information or a real decision from these tons of data. In order to extract information from a database, one has to manage these data with some parameters such as the signification of these data and the user purpose for using the data, and only then it is possible to extract information which implies an action to be done.

Most of the public and private organizations have raw data (open data, big data), but they cannot process these data in an automated way to generate information. This is explained by the fact that in the chain that leads from the data to the information (data→collection→organization→signification→purpose→information), only the two first steps of transformation are taken into account by the current information systems and technologies. The model of the information chain and the necessity to get a complete process for extracting relevant information has been discussed for many years in the information theory (Kevin Bronstein, Russel Ackoff).

The computer sets the information only with two values: the number of bits, the structure and organization of the row. The raw data lack signification which could give them a positive value, and do not meet any predetermined goal which explains the difficulty that exists today to extract relevant information.

In order to fill the two missing steps of the extracting process of information, it is necessary to take into account the preferences of agents. They are the only ones able to give signification and evaluation (according to their purpose) to the data, which will transform the raw data into useful and exploitable information.

The systems that take into account the agents preferences are quite numerous, but they have few operational applications.

Some disclosures relates to a weighted voting system. This kind of processes can be implanted in a computerized environment that allows a group of persons to vote by evaluate their preferences between several options through a weighted method. These weighted systems (Borda voting method, Schwarz voting method, voting repartition points, cumulative voting system, monetary evaluation system) are most often used in business methods, but they do not offer real operational perspective, because they produce simplified results that are adapted to evaluate objects, but that say nothing about the preferences of actors. The imperfection of weighted voting system raises an important point: the extraction of information consists not only to process data with a computer program as if it was a separated and uniformed object, but need to establish a link between the objectives of the actors with the data they want to give importance by according them a greater meaning and evaluation.

Some disclosures relate to a preferential voting systems. This kind of processes can be implanted in a computerized environment that allows a group of persons to vote by expressing their preferences between several candidates through a ranking method. These voting systems (for example: instant runoff voting, alternative vote, transferable vote) need several voting sessions in order to each time exclude the lowest ranked candidate, this means the candidate having the highest number of last preferences. This candidate is the less preferred candidate. Then a new voting session begins, and so on until there is only one candidate left who corresponds to the preference of the entire group. But as this kind of preferential voting techniques never extract the entire information from their voting sessions, potentially useful information is lost and not used. Their inefficiency explains that until now, these voting procedures have never been used in operating systems (like industrial systems, big and open data, data processing models, machine learning, predictive analytics, artificial intelligence, electronic systems), and it is to this operational deficiency that the present invention brings a solution.

There is clearly a need for a new extraction process to overcome at least some of the limitations of the existing techniques.

### SUMMARY

According to one aspect, the present invention concerns a method of extraction of information corresponding to at least one candidate data object among a plurality of candidate data objects contained in at least one database being stored in at least one storing device, and from parameters provided by evaluators and comprising evaluation criteria, the method being executed by at least one processor and comprising the following steps:
a) Retrieving the plurality of candidate data objects from the at least one database using the said evaluation criteria;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved candidate data objects;
d) For each candidate data object and each rank, processing a number of supports as a function of a number of times the said candidate rank has been assigned by evaluators to said candidate data object and as a function of the evaluation criteria;
e) Extracting said information based on the numbers of supports and generating at least one output comprising said information.

This method allows to extract information from any wide range data base by selecting the relevant data objects regarding evaluators. The evaluation criteria are configured to optimize the output of this method in order to fit as much as possible the needs of the evaluators.

Advantageously, the step a) allows the present invention to aggregate data coming from several different sources and having different format. This is made possible by retrieving the plurality of candidate data objects among a candidate data objects database. The present invention is then able to aggregate measurable data as well as unmeasurable data.

Advantageously, the steps b) allows to order the retrieved candidate data objects by preferential vote on a preference scale by assigning them to a determined rank among a set of ranks. This set of ranks is determined based on their preference levels. This allows to deliver full information contained inside the candidate data objects in order to reinforce the information extracting process.

Advantageously, the steps c) allows the evaluators to not specify all the candidate data objects, and to not rank all the candidates. Through the use of cumulative rank vector, the system will however be able to produce a classification of the candidate data objects that represents a collective preference. This important aspect insures the information consistency and allows to work on unstructured and incomplete data.

Advantageously, the step d) allows the evaluators to compare and sort the candidate data objects. Because of the process of counting the number of supports as a function of a number of times the candidate rank has been assigned by evaluators to a candidate data object, the present invention allows to obtain a wide range of information that would normally require several voting sessions using common voting processes. This aspect of the present invention decreases the processing time, increases the cost efficiency and reinforces the reliability of the process.

Advantageously, the step e) concerns the generation of one output comprising the searched information. The present invention is completely configurable in order to fit the needs of the users. By this way, this process can be applied to a wide range of systems in order to optimize their voting processes and decision making processes. The present invention is then scalable to any system requiring the extraction of information concerning several evaluators, such as, for example, a multi-agent system.

In another aspect, the invention relates to a computer program product stored in non-transitory computer-readable medium and comprising instructions adapted to perform the method of the present invention. The use of the present invention as a computer program product allows the utilization of the method in an automatic way for industrial purpose for example. The present invention can then be implanted inside a computerized environment in order to optimize any system comprising evaluators.

A computerized system is also disclosed, comprising a processor where operation of the processor in accordance with a computer program stored in a non-transitory computer-readable medium causes the computerized system to extract information corresponding to at least one candidate data object from candidate data objects contained in at least one database being stored in at least one storing device, and from parameters provided by evaluators and comprising evaluation criteria, the method of the present invention being executed by at least one processor.

The automation of the present invention allows to use it in an industrial environment such as a communication network, a security network comprising intelligent sensors, or any system comprising evaluators. Applying the present invention allows to optimize any system requiring a selection of a candidate data objects among several one when a plurality of evaluators is involved.

The present invention in one aspect thereof relates to a new operating process which is able to rank in a preferential order any quantity and any kind of data according to their meanings (their value for example) and according to a predetermined objective.

The originality of the present invention is, according to one aspect, to provide a unique process which is able to aggregate all the data coming from the evaluators preferences in order to produce the measurement of the collective preferences, and extract the information which are the most relevant according to the purpose of the process.

The efficiency of this present invention is based on two vectors—a cumulated rank support vector and a cumulated rank reject vector—which are able to produce measurements of the collective preferences regarding to the different principles of majority, unanimity, utility, equity and optimality, with only one voting session. The unicity of this process differs from all other publications and makes its originality. The unicity of this process explains its very quick, agile, economic, robust and efficient performances, which guarantee that all data is treated to produce relevant information relating to the purpose of the evaluators.

The present invention relates also to an extracting information computerized system comprising at least one processor where operation of the said at least one processor in accordance with at least one computer program stored in at least one non-transitory computer-readable medium causes the computerized system to extract information corresponding to at least one candidate data object from candidate data objects contained in at least one database being stored in at least one computerized storing device, and from parameters provided by evaluators and comprising evaluation criteria, comprising at least one processor configured to execute the following steps:
a) Retrieving candidate data objects from the at least one database using the said evaluation criteria;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved candidate data objects;
d) For each candidate data object and each rank, processing a number of supports as a function of a number of times the said candidate rank has been assigned by evaluators to said candidate data object and as a function of the evaluation criteria;
e) Extracting said information based on the numbers of supports generating at least one output.

The present invention relates also to a weather prediction system comprising a processor where operation of the processor in accordance with a computer program stored in a non-transitory computer-readable medium causes the computerized system to extract weather information corresponding to at least one weather candidate data object from weather candidate data objects contained in at least one weather database being stored in at least one computerized storing device, and from parameters provided by evaluators and comprising evaluation criteria, comprising at least one processor configured to execute the following steps:
a) Retrieving weather candidate data objects from the at least one weather database using the said evaluation criteria, the said at least one weather database containing a plurality of weather data of a predetermined territory given by at least one weather satellite looking after the said territory, and at least one weather sensor, the said evaluators comprising weather computer programs;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved weather candidate data objects;
d) For each weather candidate data object and each rank, processing a number of supports as a function of a number of times the said candidate rank has been assigned by evaluators to said weather candidate data object and as a function of the evaluation criteria;
e) Extracting said weather information based on the numbers of supports and generating at least one output.

This system allows to obtain accurate information on the climate prediction. Tt is possible to establish several data profiles that are able to consider and combine both data coming from intelligent sensors placed throughout a territory, data coming from the satellite observation, and data coming from computing systems. The evaluators can classify any types of data that correspond to the objective that has been set; it is therefore possible to develop a multi-dimensional approach in order to extract weather information from weather data of very different natures.

The present invention also relates, according to another aspect of embodiments to a multi-agent system comprising targets, robots, and at least a processor where operation of the processor in accordance with a computer program stored in a non-transitory computer-readable medium causes the computerized system to extract robot trajectories corresponding to an ordered list of target candidate data objects from target candidate data objects contained in at least one targets database being stored in at least one computerized storing device, and from parameters provided by targets and robots, and comprising evaluation criteria, the at least one processor configured to execute the following steps:
a) Retrieving an ordered list of target candidate data objects from the at least one targets database using the said evaluation criteria, the said at least one targets database containing parameters taken among: the number of targets, the size of each target, the position of each target, the number of robots, the position of each robot, the energy level of each robot, the size of each robots, the speed of each robot and the checking distance between a robot and a target which is the distance is the maximum distance between a robot checking a target;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved target candidate data objects;
d) For each target candidate data object and each rank, processing a number of supports as a function of a number of times the said candidate rank has been assigned by evaluators to said target candidate data object and as a function of the evaluation criteria;

This allows to optimize, depending of several parameters, the way to reach an objective when several agents are involved, such as several targets needing to be checked, as quickly as possible, at least by two different robots.

### BRIEF DESCRIPTION OF THE DRAWINGS

The above and further features of the invention include various novel details of the components' construction and combination. These novel features will be more particularly pointed out in the following claims, and their advantages will also become evident as they are described in detail with reference to the accompanying drawings, in which:

FIG. 1 depicts an algorithm based on the present invention;

FIG. 2 depicts an example of application of the present invention in the case of an computerized network;

FIG. 3 describes an example of the steps c and d of the present invention when the consensuality parameter and the insensitivity parameter are both put to 0;

FIG. 4 describes an example of the step d of the present invention when the consensuality parameter is put to 55% and the insensitivity parameter are both put to 33%;

The drawings are given by way of examples and are not limitative of the invention.

### DETAILED DESCRIPTION

Reference will be made in detail to the exemplary embodiments implemented according to the disclosure, the examples of which are illustrated in the accompanying drawings which will be used throughout the description.

Before providing below a detailed review of embodiments of the invention, optional characteristics that may be used in any association or alternatively are listed hereinafter:
Advantageously, the processing step d) comprises a cumulated process adding, for each candidate data object and for each rank, the number of supports, divided by a total number of evaluators, of any rank having a preference level higher than that of said each rank to the number of supports of the said each rank, divided by the total number of evaluators, thereby generating a cumulated rank support value for each rank for each candidate data object and, determining a cumulated rank support vector comprising at least one of the cumulated rank support values for each candidate data object.
Advantageously, the cumulated rank support vector of a candidate data object comprises for each rank a percentage of evaluators supporting the said candidate data object at said rank, cumulated with a percentage of evaluators supporting the said candidate data object at any ranks having a preference level higher than that of the said rank.
Advantageously, the processing step d) comprises a cumulated process generating a cumulated rank reject value for each rank and for each candidate data object and a cumulated rank reject vector for each candidate data object comprising at least one of the cumulated rank reject values, the cumulated rank reject value being for any given rank n, among the set of ranks, a number of evaluators, divided by a total number of evaluators, which rank the candidate data object in a rank having the last-but-(n−1) lowest preference level, cumulated with the cumulated rank reject value at an adjacent rank having a preference level higher than that of the given rank n.
Advantageously, the step d) comprises a cumulated process adding, for each candidate data object and for each rank, the number of supports, divided by a total number of evaluators, of any rank having a preference level higher than that of said each rank to the number of supports of the said each rank, divided by the total number of evaluators, thereby generating a cumulated rank support value for each rank for each candidate data object and, determining a cumulated rank support vector comprising at least one of the cumulated rank support values for each candidate data object.
Advantageously, the number of ranks is equal to the number of retrieved candidate data objects plus one, a last rank being called default rank and corresponding to a rank having a lowest preference level, the method comprising assigning the default rank to a candidate data object each time no data has been received from an evaluator for said candidate data object.
Advantageously, the evaluation criteria contain at least a candidate data object profile in order to retrieve the candidate data objects from the at least one database.
Advantageously, the evaluation criteria contain at least a consensuality parameter defining a majority threshold that is comprised between 0 and 1.
Advantageously, the evaluation criteria contain at least an insensitivity parameter defining an ex-aequo threshold that is comprised between 0 and 1.
Advantageously, the evaluation criteria contain at least a primary objective.
Advantageously, the evaluation criteria contain at most several primary objectives defining a multicriteria ballot.
Advantageously, the evaluation criteria are common to all the evaluators.
Advantageously, the evaluation criteria are common to at least some of the evaluators.
Advantageously, the evaluation criteria of at least two evaluators are different.
Advantageously, the cumulated rank support vectors and/or the cumulated rank reject vectors generate the at least one output depending on the at least one consensuality parameter defining a threshold that is comprised between 0 and 1.
Advantageously, the at least one consensuality parameter defines a majority threshold.
Advantageously, the at least one consensuality parameter defines a minority threshold.
Advantageously, the cumulated rank support vectors and/or the cumulated rank reject vectors generate the at least one output depending on the at least one insensibility parameter defining an ex-aequo threshold that is comprised between 0 and 1.
Advantageously, the at least one output is at least one output taken among the following outputs: a quantified majority output, a unanimity output, a utility output, an equity output, an optimum output, a multicriteria output.
Advantageously, the computerized system comprises evaluators wherein each evaluator is at least one entity taken among: sensor, network node, human being, computer program.
According to an embodiment, the step d) is a cumulated process generating both a cumulated rank support vector and a cumulated rank reject vector for each candidate data object.
According to an embodiment, the number of ranks is based on the number of retrieved candidates.
According to an embodiment, the evaluator is at least one entity, real or virtual, taken among: sensor, network node, human being, animal, computer program.
According to an embodiment, the evaluator is at least one entity real or virtual.
According to an embodiment, the extracted information is a weather prediction concerning at least one geographical area, wherein the at least one database is a weather database comprising weather candidate data objects provided by at least one satellite looking after the at least one geographical area and by at least one weather sensor, and wherein the evaluators comprise at least one weather computer program in order to predict the weather of the at least one geographical area.
According to an embodiment, the extracted information is the name of a person which is elected by a group of evaluators, wherein the candidate data objects are the name of each candidate to the election provided by at least one list of candidates' names, and wherein the group of evaluators comprises at least two persons.
According to an embodiment, the extracted information is a set of signals for transport network, wherein the candidate data objects are data collected by sensors inside the transport network, and wherein the evaluators comprise at least one traffic optimization computer program in order to improve the smoothness of the traffic.
According to an embodiment, the extracted information is a set of environmental parameters of a building in order to reduce its energy cost, wherein the candidate data objects are data collected by sensors inside the building, and wherein the evaluators comprise at least a group of person living inside the building.
According to an embodiment, the extracted information is a specific genetic data sequence, wherein the candidate data objects are unstructured genetic data contained inside a genetic database, and wherein the evaluators comprise at least one restructuring genetic data computer program configured in order to restructure the specific genetic data sequence.
According to an embodiment, the extracting information is a set of trajectories for a set of robots, wherein the candidate data objects are targets contained in a targets database comprising several parameters regarding features of targets and robots, and wherein the evaluators are the said robots and each comprise at least one program configured to evaluate a trajectory to follow to reach the said targets.

It is indicated that according to the present invention, the word “candidate” and its synonyms have as definition: any real and/or virtual entity being able to be considered and stored as a data in a database. For example a candidate can be any numerical data, any lexicographic data, it can represent something real as well as something virtual, and it can be anything from a simple voltage value or any numerical data to the name of a person or of a group of persons or any lexicographic data.

It is indicated that according to the present invention, the word “vote” and its synonyms have as definition: the action to express by any means a preference between at least two candidates. For example, a vote can be made between several voltage values for an electronic component as well as between several people for a position.

It is indicated that according to the present invention, the words “voter”, “evaluator” and theirs synonyms have as definition: any entity —real and/or virtual-being able to express by any means a preference between at least two candidates, that means that an evaluator is an entity realizing a vote. For example, an evaluator can be a computer program as well as a person or a group of persons.

It is indicated that according to the present invention, the word “rank” and its synonyms have as definition: a level of an evaluator's preference for a candidate. A candidate is assigned a rank during a vote. The highest rank may be 0 for example.

It is indicated that according to the present invention, the word “ballot” and its synonyms have as definition: the entirety of all votes completed by evaluators about all the candidates.

It is indicated that according to the present invention, the function “vote” and its synonyms have as definition: we note [symbol] the set of candidates and [symbol] the set of evaluators. We also consider the special set [symbol] =[|0, | [symbol] |−1|]. [symbol] represents the set of ranks (one rank per candidate). It has to be noted that, since [symbol] belongs to [symbol] (the set of natural number), a function from [symbol] to a certain type [symbol] can be viewed as a vector of [symbol] values. The function named Voteᵢ considers the ballot of Evaluator i and assigns a rank to each candidate. If the candidate is supported by voter i, its rank will be from 0 (the best rank) to | [symbol] −1| (the worst rank). If it is rejected, it will be +∞. Voteᵢ(a)=r means that Evaluator i would like Candidate a to get Rank r.

Voteᵢ: [symbol] →

[symbol]

aεTᵢ [symbol] 0≦Voteᵢ(a)≦| [symbol] |

aε⊥ᵢ [symbol] Voteᵢ(a)=+∞

It is indicated that according to the present invention, the terms “cumulated rank support vector of a candidate” and its synonyms have as definition: For any candidate aε [symbol] , Rankₐ^{Support}: [symbol] [0,1] associates to each rank the percentage of evaluators which support Candidate a up to this rank.

$$∀ a ∈ , \\ {Rank}_{a}^{Support} \text{:} \to [ 0 , 1 ]$$

$$r ↦ \frac{\vert \{ i ∈ \vert {Vote}_{i} ( a ) \leq r \} \vert}{\vert \vert}$$

For any candidate, the cumulated rank support vector indicates:
In the first position, the percentage of evaluators which most support the candidate;
In the second position, the percentage of evaluators which support the candidate but consider that it should not be ranked first;
In the third position, the percentage of evaluators which support the candidate but consider it should be ranked last or last-but-one;
In the last position, the percentage of evaluators which do not support the candidate (evaluators who did not rank the candidate).

It is indicated that according to the present invention, the terms “cumulated rank reject vector of a candidate” and its synonyms have as definition: For any candidate aε [symbol] , Rankₐ^{Reject}: [symbol] →[0,1] indicates:
In the first position, the percentage of evaluators who do not support the candidate (evaluators who did not rank the candidate);
In the second position, the percentage of evaluators which support the candidate but consider it should be ranked last;
In the third position, the percentage of evaluators who support the candidate but consider it should be ranked last or last-but-one;
. . .
In the last position, the percentage of evaluators who support the candidate but consider it should be ranked any rank but the first.

It has to be noted that the cumulated rank reject vector of a candidate can be obtained by a transformation of the cumulated rank support vector:

$$∀ a ∈ , \\ {Rank}_{a}^{Reject} \text{:} \to [ 0 , 1 ]$$

$$r ↦ \frac{\vert \{ i ∈ \vert {Vote}_{i} ( a ) \leq ( \vert \vert - r ) \} \vert}{\vert \vert}$$

It is indicated that according to the present invention, the terms “lexicographic order” and its synonyms have as definition: Let a=a₁a₂ . . . aₙ and b=b₁b₂ . . . bₙ be two vectors of [symbol] ( [symbol] being the set of real number).

a>^{lex}b [symbol] ∃r≦n, ∇q<r, a_{q}=b_{q} [symbol] aᵣ<bᵣ

It is indicated that according to the present invention, the terms “lexicographic semi-order” and its synonyms have as definition: Let a=a₁a₂ . . . aₙ and b=b₁b₂ . . . bₙ be two vectors of [symbol] ⁿ and ε∈[0,1] a threshold. The lexicographic semi-order with regard to ε will prefer the candidate that has a support higher (or a rejection lower) by at least a margin of E on the lowest rank.

a>_{ε}^{lex}b [symbol] ∃r≦n, ∇q<r, |a_{q}−b_{q}|<ε [symbol] |aᵣ−bᵣ|≧ε

It is indicated that according to the present invention, the terms “support maximization” and its synonyms have as definition: For two candidates a and b, a [symbol] ^{support} b holds if a has a higher support than b at the lower rank. This ordering promotes the candidates which are more often the first (the preferred) choices of the evaluators.

a>^{support}b [symbol] Rankₐ^{Support}>^{lex}Rank_{b}^{Support}

It is indicated that according to the present invention, the terms “reject minimization” and its synonyms have as definition: For two candidates a and b, a [symbol] ^{reject} b holds if a is less often rejected (i.e. it belongs to T) than b and is less often ranked in the last position. This ordering promotes the candidates which are less rejected by the evaluators.

a [symbol] ^{reject}b [symbol] Rankₐ^{reject}<^{lex}Rank_{b}^{reject}

It is indicated that according to the present invention, the terms “consensuality parameter” and its synonyms have as definition: the consensuality parameter is a threshold ∇ε[0, 1], that affects the cumulated rank vectors of the candidates. Every evaluation of the ranks that a candidate should have on the cumulated vectors that does not reach the consensuality level (a percentage of evaluators lower than the required one) is processed as if nobody ranked this candidate. More specifically, for any cumulated rank vector, any value below the threshold is replaced by zero.

It is indicated that according to the present invention, the terms “rank of a candidate with regard to a given consensuality level” and its synonyms have as definition: Let's Rankₐ* be a cumulated rank vector (support or rejected) for Candidate a and ∇ε[0, 1], the threshold over consensuality. The application of this threshold over the vector results in the cumulated rank vector with regard to the consensuality level, Rankₐ* (∇) defined as follows:

$${Rank}_{a}^{*} ( ∇ ) \text{:} \to [ 0 , 1 ]$$

$$r ↦ \{ \begin{matrix}{Rank}_{a} ( r ) & if {Rank}_{a} ( r ) \geq ∇ \\ 0 & otherwise\end{matrix}$$

It is indicated that according to the present invention, the terms “insensitivity parameter” and its synonyms have as definition: the insensitivity parameter is a threshold ε∈[0,1], when the objective of the vote is to identify the candidates which have succeeded in making a difference with their competitors. Indeed, this procedure will make two candidates ex-aequo which support (or reject) difference does not exceed a certain threshold, ε∈[0,1], called insentivity. This is done by using semi-orders instead of [symbol] natural orders when comparing with the lexicographic order. Semi-orders are the family of orders that does not verify transitivity for the equivalence relation (and only this one). That means one can have a˜b, b˜c but a [symbol] b. Then Candidate a is declared as preferred to Candidate b on a given cumulated rank if its support (respectively its rejection) is higher (respectively lower) than the one of Candidate b by a margin of ε.

It is indicated that according to the present invention, the term “ex-aequo” and its synonyms have as definition: two or more candidates are considered as ex-aequo when they obtain the same number of votes on the rank corresponding to the level of the consensuality parameter, and when support or reject difference does not exceed a certain threshold, ε∈[0,1], called insentivity parameter.

It is indicated that according to the present invention, the terms “strict ordinal ballot of evaluator i” and its synonyms have as definition: The evaluator is invited to express its choice by defining a strict ordering over the candidate of its supported set, [symbol] ᵢ. In a given evaluator ballot, the rank of a given candidate is equal to the number of candidates ranked before it Hence, the preferred candidate gets rank 0, the second preferred candidate gets rank 1, etc. Non ranked candidates belong to ⊥ᵢ and thus have rank +∞. Let >ᵢ be an anti-symmetric, irreflexive, transitive binary relation over the candidates of Tᵢ.

Voteᵢ: [symbol] →

[symbol]

aεTᵢ [symbol] |{bε [symbol] |b>ᵢa}|

aε⊥ᵢ [symbol] Voteᵢ(a)=+∞

It is indicated that according to the present invention, the terms “weak ordinal ballot of evaluator i” and its synonyms have as definition: The evaluators is invited to express its choice by defining a weak ordering over the candidates of its supported set. This ordering is defining by using, for each couple of candidates either a strict preference, >ᵢ, or an equivalence preference, ≡ᵢ. The evaluator's ordering being transitive, if two candidates, Candidate a and Candidate b, have been defined as equivalent, and if Candidate a is strictly preferred to a third candidate, Candidate c, the Candidate b is also strictly preferred to Candidate c. In this case, the evaluator i can express that:
Candidate a and Candidate b should have the same rank, according to evaluator I (since they are equivalent);
Candidate c should have a lower rank than both Candidate a and Candidate b, according to evaluator I (since the latters are preferred to the former);

Let >ᵢ be an anti-symmetric, irreflexive, transitive binary relation over the candidates of Tᵢ and ≡ᵢ be a symmetric preorder over the candidates of Tᵢ, such that >ᵢ∩≡ᵢ=Ø (the evaluator must always specify whether the candidates are equivalent, or whether one of them is strictly preferred). The rule to define Voteᵢ is basically the same as the one of the strict ordinal ballot case, and, similarly, only strict preferences are considered: the rank of a candidate is equal to the number of other candidates that are strictly preferred to it.

Voteᵢ: [symbol] →

[symbol]

aεTᵢ [symbol] |{b ε [symbol] |b>ᵢa}|

aε⊥ᵢ [symbol] Voteᵢ(a)=+∞

It is indicated that according to the present invention, the term “weak cardinal ballot” has as definition: The evaluator is invited to express its choice by defining a rate for the candidate of its supported set. This is a rating ballot. In this procedure, the evaluator is invited to express its choice by directly defining Voteᵢ. The function named Voteᵢ considers the ballot of evaluator i and assigns a rank to each candidate. If the candidate is supported by Voterᵢ, its rank will be from 0 (the best rank) to |A−1| (the worst rank). If it is rejected, it will be +∞. Voteᵢ (a)=r means that evaluator i would like Candidate a to get Rank r.

Voteᵢ: [symbol] →

[symbol]

aεTᵢ [symbol] 0≦Voteᵢ(a)≦| [symbol] |

aε⊥ᵢ [symbol] Voteᵢ(a)=+∞

The evaluator expresses its choice by defining a weak cardinal order over the candidates of its supported set. This ordering is defined by using a rate for each candidate. If the evaluator gives the same rate to a couple of candidates, it expresses an equivalence preference. If the evaluator gives a different rate to a couple of candidates, it expresses a strict preference. This means that “weak cardinal ballot” allows each evaluator to rate all the candidates of its supported set by using either a strict preference, >ᵢ, or an equivalence preference, ≡ᵢ.

The difference between “weak cardinal ballot” and “weak ordinal ballot” lies in the fact that for a given evaluator ballot, the rank of a given candidate is not always equal to the number of candidates ranked before it. This characteristic means that in a “weak cardinal ballot”, each candidate is independent regarding to the rational criteria of non-relevant alternatives. In a “weak ordinal ballot”, if an evaluator expresses an equivalence preference for three candidates on the rank 0, the fourth candidate will be necessarily on the rank 3. In a “weak cardinal ballot”, if an evaluator expresses an equivalence preference for three candidates on the rank 0, the fourth candidate can be either on the rank 1, 2, 3 4, . . . . It is always possible for an evaluator to not rank a candidate, which would mean that this candidate is not supported and not rejected (it belongs to ⊥ᵢ and thus have rank +∞).

The “weak cardinal ballot” gives many liberty of expression to the evaluators. They can rate each candidate like they want, without being obliged to provide a strict or a weak ordinal order of preference. The rating ballot is useful to allow evaluators to give a precise measurement of their preference about a candidate. The rating ballot is recommended for evaluators which have little information about the candidates, or for evaluators which are asked to classify a huge quantity of candidates, and which have more facility to compare them with cardinal values rather than with ordinal values.

In this rating ballot, the scale is automatically defined by the number of candidates. By exception, the scale can be superior or inferior to the number of candidates, if the purpose pursued by the evaluators makes it necessary (for a better data treatment for example). In this exceptional case, it will be possible to use a public, scientific and universal reference as a scale for the rating ballot.

For example, a group of evaluators wanting to evaluate the future intensity of an earthquake in a specific geographical area can use the Richter scale as their “weak cardinal ballot” scale. This possibility to use a universal scale as a ballot scale eliminates all arbitrariness in defining scale (arbitrariness concerning the number of ranks and their values).

It is indicated that according to the present invention, the terms “consensuality level” and its synonyms have as definition: a choice match a certain consensuality level if the required percent of the evaluators have agreed on this choice. Certain levels are of interest, levels between 0% and 100% are called ‘majority’, and level equal to 100% is called ‘unanimity’. The consensuality level is used in both ‘support maximization’ and ‘reject minimization’. In our context, the consensuality level is first associated to the fact that the candidate is supported or not. Hence, if the procedure has been configured to respect a consensuality level of x %, a candidate, that is not supported (i.e. ranked) by at least x % of the evaluators, cannot be ranked on the final choice. For example, if the consensuality level is 100% (unanimity), it means that each evaluator considers that the winner is an acceptable choice, even if some evaluators may have ranked him last. Note that the computation of the winner under a given consensuality level is actually more precise, since the required consensuality level is applied on each rank. Hence, given two candidates, A and B, that are both consensually supported, A cannot win over B on rank k if A did not satisfied yet the required consensuality on this rank. Consensus allows to impose a quantification on the required support of a candidate for him to be elected. Support maximization with a consensuality level is thus a refinement of quantified plurality.

It is indicated that according to the present invention, the terms “quantified majority” and its synonyms have as definition: The consensuality parameter allows to impose a quantification on the required support of a candidate for it to be elected. The quantification on the required support of a candidate to be elected takes the form of a quantified majority. More specifically, the quantified majority is the level corresponding to the consensuality parameter decided for a ballot, only in the case where evaluators use the cumulated rank support vector. In this perspective, the winner is the candidate which gets the most votes on the best rank which corresponds to the consensuality parameter. For example, if the candidate A gets a number of votes which allows it to exceed the threshold of quantified majority on the second preference rank, and if the candidate B obtains a number of votes which allows it to exceed the threshold of quantified majority on the third preference rank, then the winner will be the candidate A. Support maximization with a consensuality level inferior is thus a refinement of quantified plurality.

It is indicated that according to the present invention, the word “quantified unanimity” and its synonyms have as definition: The level of consensuality parameter allows to impose a quantification on the required support of a candidate for it to be elected. When the quantification on the required support of a candidate to be elected is equal to 100% of the votes, the ballot takes the form of a quantified unanimity. A candidate which obtains 100% of the votes is selected as relevant information, even if some evaluators ranked it on the last rank. A candidate which obtains 100% of the votes on the best preference rank is the winner. More specifically, the “unanimity choice” is preconfigured with the highest level of consensuality parameter 100%, in the case where the evaluators use the cumulated rank support vector. The “unanimity” with a consensuality level is a refinement of unanimity voting.

It is indicated that according to the present invention, the terms “utility procedure” and his synonyms have as definition: a procedure is utilitarian when the returned alternative is the one associated to the best overall value. The classical measurement of a candidate utility is to sum the utility granted to this candidate by each of the evaluators. No matter of the difference of opinion, a candidate has a higher utility if it brings a better value to the evaluators' purpose as a whole. Depending on the context, the utility procedure is used to obtain relevant information about, for example, the gain maximization, the performance maximization, the production maximization, the security maximization, the speed maximization, the stability maximization, the sustainability maximization, the treatment maximization, about what is considered as the most satisfying, about what is considered as the most wanted or needed by all the evaluators. The ‘support maximization’ configuration of the procedure achieves utilitarism by focusing on the candidates that have been declared the best choices by the higher number of evaluators. Note that ‘support maximization’ is a refinement of plurality voting.

It is indicated that according to the present invention, the terms “equity procedure” and his synonyms have as definition: a choice procedure is equitable when the returned alternative is equally profitable (or unprofitable) to each evaluators. It is classically defined as determining the alternative for which the interest of the less favored candidates is the highest. The equity procedure is recognized to be safe and fair, because of its strong egalitarism. Depending on the context, the equity procedure is used to obtain relevant information about, for example, the loss minimization, the risk minimization, the unproductivity minimization, the slowness minimization, the load minimization, the distance minimization, the consummation minimization, the pollution minimization, the instability minimization, the default minimization, the disturbance minimization, the uncertainty minimization, about what is considered as the less unsatisfactory for each evaluators, because this egalitarian procedure tends to minimize the unsatisfaction of the less satisfied evaluators. The ‘reject minimization’ configuration of the procedure achieves egalitarianism by focusing on eliminating the candidates that are not at all supported or that are less supported by some evaluators. By eliminating those candidates without taking into account whether they are highly supported by other evaluators or not, the equity procedure selects the candidates that will minimize the unsatisfaction of the less satisfied evaluators. Note that ‘reject minimization’ is a refinement of approval voting.

It is indicated that according to the present invention, the word “optimum procedure” and its synonyms have as definition: for a given set of votes, an “optimum procedure” is the one that gives the same order of preference with the lowest consensuality level in support maximization and in reject minimization.

a>ₒₚₜᵢₘᵤₘb [symbol] a>ₛᵤₚₚₒᵣₜb [symbol] a>_{reject}b

An “optimum procedure” is verified if for any couple of candidates a and b:

support(a)=support(b), which implies that reject(a)=reject(b)

or

a>ₛᵤₚₚₒᵣₜb [symbol] a>_{reject}b

or

b>ₛᵤₚₚₒᵣₜa [symbol] b>_{reject}a

The “optimum procedure” allows to identify the candidates which are both the most supported in the cumulated rank support vector, and the less rejected in the cumulated rank reject vector. Coming from the combination of the support maximization and the reject minimization, the “optimum procedure” can be considered as congruent and balanced. This hybridization of “utility procedure” and “equity procedure” achieves congruence by focusing on eliminating the cleaving candidates which obtain big support and big reject. By eliminating those cleaving candidates, only the candidates that both minimize the unsatisfaction and maximize the satisfaction of a very large quantity of evaluators are selected. “Optimum procedure” confirms the fact that in certain conditions depending of the consensuality parameter that it is chosen, it exists a symmetric order between support maximization and reject minimization. If this symmetric order is not verified, the final ranking resulting from the comparison of the “cumulated rank support vector” and the “cumulated rank reject vector” is not considered as congruent, and the two vectors are not optimized.

It is indicated that according to the present invention, the terms “multicriteria ballot” and its synonyms have as definition: a multicriteria ballot is a criterion function which indicates a real valued function on X that directly reflects the worth or the best value of the elements in X according to some criteria or primary objectives.

Consider a set of primary objectives (j=1, . . . n) where each ballot represents one criterion: a multicriteria ballot is a ballot that realizes the aggregation of several ballots or objectives. This aggregation of several ballots or objectives corresponds to a criterion function gⱼ: X→R, where each x in X is mapped into an n-tuple (g₁(x), . . . gₙ(x)) of criterion values, scores or utilities. It is then possible to associate some levels of preference or values with these n-tuples. It is often assumed, for example, that preference monotonically increases in each gⱼ.

In the case of the present invention, the comparison of the votes obtained by each candidate on each ballot representing a primary objective is achieved by the sum of the total number of the votes of each ballot. This procedure products a new ballot that synthesizes all the results. The use of the consensuality parameter in the new ballot gives a final order of the candidates which are the most supported and the less rejected in the average sum of all the criteria. It is also possible to identify the candidates that are the most supported in the cumulated rank support vector, and to identity the candidates that are the most rejected in the cumulated rank reject vector.

It is indicated that according to the present invention, the terms “ex-aequo reduction” and its synonyms have as definition: a procedure which tends to produce a collective order of preference between a set of candidates considered as ex-aequo. Consider a set of two candidates at least (A, B, C . . . ) which are ex-aequo at rank N. The “ex-aequo reduction” procedure searches rank by rank, from the rank N+1 to the last rank (equal to the set of ranks R), if any candidate gets the highest number of votes. The candidates which get the most of the votes in a rank superior to N and inferior or equal to R are classified according to the rank of preference where they get a difference of votes in their favor.

If at least two candidates are ex-aequo at the rank R, the “ex-aequo reduction” procedure will search in each rank between rank R−1 and rank 0 which candidate gets the highest number of votes. The candidates which get the highest number of votes in a rank inferior to R and superior or equal to rank 0 will be classified according to the rank of preference where they get a difference of votes in their favor. This procedure will be useful in the case where the evaluators work with a high consensuality parameter, because a consensuality level of 100% increases statistically the possibility to obtain many ex-aequo. Note that the “ex-aequo reduction” procedure which is searching from rank R to rank 0 to make the difference in favor of the candidate which gets the most cumulated votes can be considered as an equivalence of the “cumulated rank reject vector”.

The “ex-aequo reduction” procedure is interesting because it uses a large range of information that achieves a ranking with the highest possible consensuality level.

To be able to extract information, a purpose has to be defined. And to have a purpose, at least one evaluator has to be defined as well. The evaluator has a goal to achieve, and to do that there are several ways. Each way is a data. For example, by using the present invention, the evaluator is able to decide the best ways to reach a goal. In a case of only one evaluator, it is quite easy to extract the relevant information, but when several evaluators are involved, the situation becomes quickly more complicated. In case of hundreds or thousands of evaluators (which can be for example a community of people, a network of servers, a group of computers, a set of detectors) or in case of hundred thousand of data (like for example big data, or weather forecasting data) it becomes absolutely necessary to have a structured process that extracts the desired information from the database. In fact, the goal has to be common to all the evaluators. Then, each of them has to rank the data considered as candidates in order to obtain a ballot.

When all the candidates are ranked, the present invention is able to extract information, such as what are the candidates having the lowest and the highest ranks. On the basis of a cumulated process generating both a cumulated rank support vector and a cumulated rank reject vector for each candidate data object, it becomes possible to have access to precise information about, the majority choice including all the levels of the quantified majority, the unanimity choice, the utility choice, the equity choice, the optimum choice, and the multicriteria choice.

Therefore, the candidate which gets the best place in the collective order of preference of the evaluators is considered as the information from which the meaning is the most relevant to reach the goal set at the beginning of the extracting information process.

The present invention takes place in a computerized environment. It processes to the extraction of information from data contained in at least one database.

For example, the present invention can take place in any computerized system comprising a network with nodes. This network can be real, made of people, sensors and/or computers, or completely virtual made of programs, functions and so on. Any node of any network can be an evaluator.

The invention can take place in a computerized system comprising a processor where operation of the processor in accordance with a computer program stored in a non-transitory computer-readable medium causes the computerized system to extract information corresponding to at least one candidate data object from candidate data objects contained in at least one database being stored in at least one storing device, and from parameters provided by evaluators and comprising evaluation criteria, the method of the present invention being executed by at least one processor.

This computerized system can comprise evaluators wherein evaluators which are at least one entity taken among: sensor, network node, human being, computer program for example.

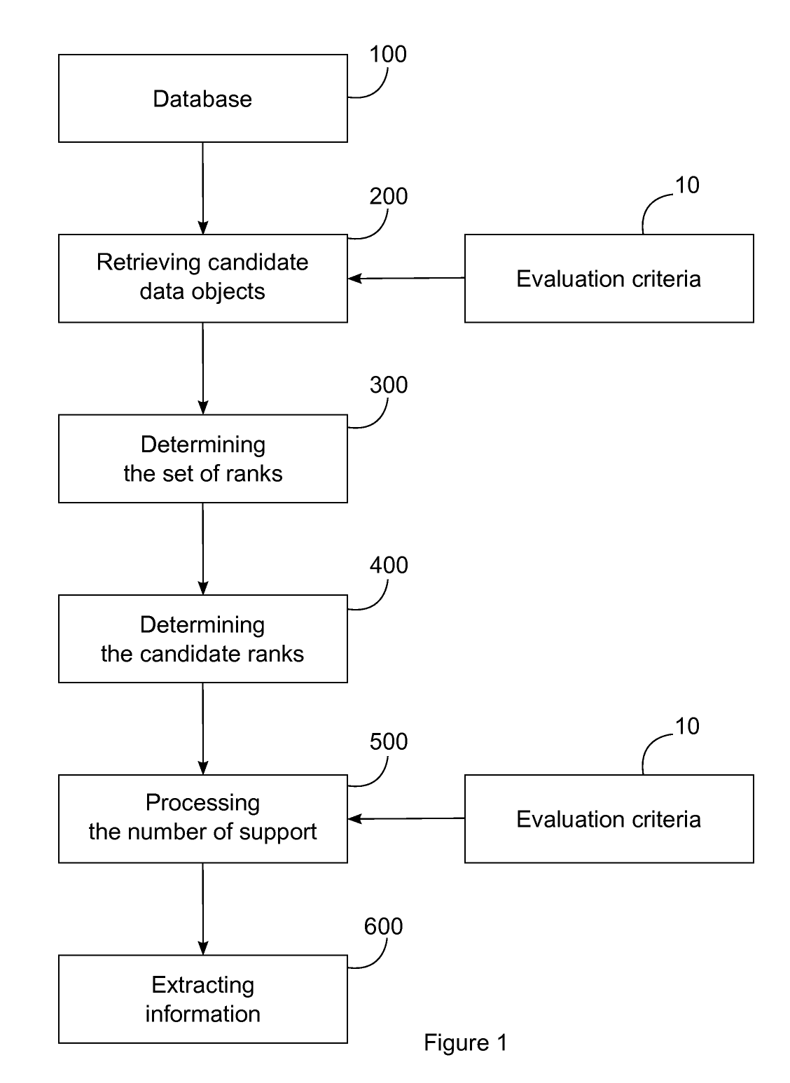

According to one embodiment and as shown in FIG. 1, the present invention relates to a method of extraction of information corresponding to at least one candidate data object among a plurality of candidate data objects contained in at least one database 100 being stored in at least one storing device, and from parameters provided by evaluators and comprising evaluation criteria 10, the method being executed by at least one processor and comprising the following steps:
a) Retrieving 200 the plurality of candidate data objects from the at least one database using the said evaluation criteria 10;
b) Determining 300 a set of ranks each having a different preference level on a preference scale, wherein the ranks are sorted on the preference scale according to their preference levels;
c) Determining 400, for each evaluator, a candidate rank assigned, among the set of ranks, to each of the retrieved candidate data objects;
d) For each candidate data object and each rank, processing 500 a number of supports as a function of a number of times the said candidate rank has been assigned by evaluators to said candidate data object and as a function of the evaluation criteria 10;
e) Extracting 600 said information based on the numbers of supports and generating at least one output comprising said information.

This method allows a group of evaluators to extract information from a database. For example, during an election, this method could be used in order to determine the elected candidate. As the same time, this method can be used in computerized environment comprising intelligent sensors in order to adjust some parameters to each sensor to achieve a better sensibility for example.

According to one embodiment, the evaluation criteria 10 contain at least a primary objective. The primary objective is essential to the system. Actually, this primary objective is the main goal to reach for the evaluators.

For example, this goal can be to fill a president position, to increase the sensibility of sensors, to find the best communication server in order to have the best upload rate more generally any situation where several evaluators have to find the best candidate for a precise objective.

According to one embodiment, the evaluation criteria 10 contain a primary objective for each evaluator.

According to one embodiment, the evaluation criteria 10 contain at least one primary objective.

According to one embodiment, some secondary objectives can be contained inside the evaluation criteria 10 needing a larger set of data objects because the data profile is then less restrictive, the primary and secondary objectives being taken into account.

According to one embodiment, the evaluation criteria 10 contain at least a data profile in order to select the required data objects from the at least one database 100. This data profile is directly link to the evaluators' nature and to the primary objective registered inside the evaluation criteria. This data profile selects only the needed data object from the database 100 in order to reduce the processing time. These selected data are called candidate data objects.

It is obvious that, for example, to obtain information about what voltage to apply to some intelligent sensors acting as evaluators, it is only useful to handle data corresponding to voltage values for example. Then the data profile acts as a filter in order to select only the data objects susceptible to be useful for the evaluators' primary objective.

According to one embodiment, the evaluation criteria 10 may contain at least one consensuality parameter and/or at least one insensitivity parameter. These parameters allow to optimize the output of the method in order to fit the primary objective of the evaluators.

According to one embodiment, the at least one consensuality parameter defines a majority threshold that is comprised between 0 and 1.

According to one embodiment, the at least one insensitivity parameter defines an ex-aequo threshold that is comprised between 0 and 1.

According to an advantageous and preferred embodiment, all the evaluators share the same evaluation criteria 10.

According to one embodiment, each evaluator has its own evaluation criteria 10. In this situation, the process uses a native evaluation criteria (implanted inside the core of the system for example) in order to run a first process to obtain the optimized evaluation criteria 10 applicable to all the evaluators, and then the process is run again in order to extract the information needed by the evaluators. This situation is optimizing the evaluation criteria 10 in order to obtain the most relevant information.

According to one embodiment, the retrieving step a) 200 is about the execution of the evaluation criteria 10 over the at least one database 100 in order to identify and select a set of data objects corresponding to the data profile contained inside the evaluation criteria 10. This set of data objects comprises candidate data objects. A candidate data object—also simply called candidate in the description—can be any kind of data.

This retrieving step a) 200 allows to reduce the time needed to execute the method of the present invention by selecting only data objects from which information can be useful for at least one of the evaluators.

For example, for the election of Miss America, only women between 17 and 24 years old have to be considered. Then in the database 100 containing all women of any age of a defined city, only few of them have to be taken into account. The step a) 200 allows to select only women in a good range of age for this competition, these women then becomes the candidates.

Another example is about voltage applying on intelligent sensors. In a database 100 containing voltage and current intensity, only the data about voltage are useful. Then the step a) 200 allows to select only the data about voltage as candidates.

According to one embodiment these candidate data objects are at least two different candidate data objects.

According to one embodiment, the determining step b) 300 is about establishing a set of ranks, each rank having a different preference level on a preference scale. These ranks are then sorted on the preference scale according their preference level.

Advantageously, the number of ranks is equal to the number of retrieved candidate data objects plus one, a last rank being called default rank and corresponding to a rank having a lowest preference level, the method comprising assigning the default rank to any candidate data object each time no data has been received from an evaluator.

Advantageously, the number of ranks is equal to the number of retrieved candidate data objects plus one. In the cumulated rank support vector, the default rank is defined as the last rank. In the cumulated rank reject vector, the default rank is defined as the first rank. In support and reject vector, the default rank is corresponding to a rank having the lowest preference level, the method comprising assigning the default rank to any candidate data object each time no data has been received from an evaluator.

According to one embodiment, this default rank is assigned to any candidate that is not supported by an evaluator. Without any support from any evaluator for a candidate, the said candidate is ranked to the default rank.

A candidate ranked to the default rank can be understood as missing information. The extracting process of this invention is able to produce relevant information resulting from the collective order of preferences, although some information are missing. The robustness of the extraction process of the relevant information can be very important in the case where it is necessary to grant the monitoring and the maintenance of a system or a service, which can be for example a smart grid, a traffic signal network, a chain of military command, a risk management system, a nuclear power plant, an air traffic system, or a smart sensors system, which are all acting as evaluators.

According to one embodiment, the determining step c) 400 is about determining, for each evaluator, a candidate rank assigned to each of the retrieved candidate data object.

According to one embodiment, each candidate data object is assigned to at least one rank.

According to one embodiment, the candidate data objects are ranked according to the preference of each evaluator generating a preference ballot for each evaluator.

According to one embodiment, if a candidate data object has received no assignment following the step c) 400, this candidate data object is automatically assigned the default rank.

According to one embodiment, the default rank is used to rank the candidate data objects that the evaluator doesn't want to rank.

According to one embodiment, each evaluator expresses by any means and notably by default its preference about each candidate data object. This preference expression corresponds to the ranking of each candidate data object leading to the determination of a candidate rank.

According to one embodiment, at least two candidate data objects can be assigned to the same rank by a given evaluator.

According to another embodiment, the candidate data objects have different ranks for a given evaluator.

According to one embodiment, at least two candidate data objects can be assigned to the same rank by a given evaluator. This condition only applies to the procedure of the weak ordinal ballot and to the procedure of the weak cardinal ballot.

According to one embodiment, at least one candidate data object can be assigned to the same rank by a given evaluator. This condition only applies to the procedure of the strict ordinal ballot.

According to another embodiment, the candidate data objects have different ranks for a given evaluator. This condition applies for all the procedures, weak ordinal ballot, weak cardinal ballot, and strict ordinal ballot.

According to one embodiment, the processing step d) 500 is about, for each candidate data object and each candidate rank, processing a number of supports, divided by the number of evaluators, as a function of a number of times the said candidate rank has been assigned by evaluators to the said candidate data object and as a function of the evaluation criteria 10.

According to one embodiment, only the consensuality parameter is taken into account in the processing step d) 500. This parameter is used in order to determine what the elected candidate is. This parameter is configured to fit with the primary objective. For example, if the present invention is apply for the election at the absolute majority of a senator, then the consensuality parameter has to be put to 0.51 for example.

According to one embodiment, only the insensitivity parameter is taken into account in the processing step d) 500. This parameter is used in order to consider to candidate data objects closed enough as an ex-aequo situation.

According to one embodiment, both the consensuality parameter and the insensitivity parameter are taken into account in the processing step d) 500.

Adjusting these two parameters allows to optimize the output of the present invention as a function of the primary objective.

According to one embodiment, the processing step d) 500 is a cumulated process adding, for each candidate data object and for each rank, the number of supports, divided by a total number of evaluators, of any rank having a preference level higher than that of said each rank to the number of supports of the said each rank, divided by the total number of evaluators, thereby generating a cumulated rank support value for each rank for each candidate data object and, determining a cumulated rank support vector comprising at least one of the cumulated rank support values for each candidate data object.

According to one embodiment, these cumulated rank support values are the percentage of evaluators supporting a candidate data object at a rank cumulated with percentage of evaluators supporting the said candidate data object at the adjacent rank having the higher preference level. The representation of the cumulated rank support values as percentage is an easy way to intellectualize the cumulated rank support values and their meanings.

According to one embodiment, the processing step d) 500 is a cumulated process generating a cumulated rank reject value for each rank and for each candidate data object and a cumulated rank reject vector for each candidate data object comprising at least one of the cumulated rank reject values, the cumulated rank reject value being for any given rank n, among the set of ranks, a number of evaluators, divided by a total number of evaluators, which rank the candidate data object in a rank having the last-but-(n−1) lowest preference level, cumulated with the cumulated rank reject value at an adjacent rank having a higher preference level than the given rank n.

This cumulated rank reject vector is mathematically link to the cumulated rank support vector. This cumulated rank reject vector is a way to emphasize the candidates which are less rejected whereas the cumulated rank support vector is a way to emphasize the candidates which are more supported.

According to one embodiment, the processing step d) 500 is a cumulated process generating a cumulated rank reject value for each rank of each candidate data object, and a cumulated rank reject vector for each candidate data object.

According to one embodiment, these cumulated rank reject values are for example:
In the first rank, the number of evaluators which do not rank the candidate data object;
In the second rank, the number of evaluators which rank the candidate data object in the last rank, cumulated with the value of the said first rank;
In the third rank, the number of evaluators which rank the candidate data object in the last-but-one rank, cumulated with the value of the said second rank;
In the fourth rank, the number of evaluators which rank the candidate data object in the last-but-two rank, cumulated with the value of the said third rank;
And so on for each rank;
In the last rank, the number of evaluators which rank the candidate in the first rank, cumulated with the value of the last-but-on rank.

According to an embodiment, the processing step d) 500 is a cumulated process generating a cumulated rank support vectors and/or a cumulated rank reject vector for each candidate data objects. This generation of both the cumulated rank support vectors and the cumulated rank reject vectors allows in a single run or cycle of the present invention to extract information about the most supported candidate data object as well as the lowest rejected one. By applying consensuality parameter and insensitivity parameter, one is able to extract a wide range of information.

According to an embodiment, the cumulated rank support vector and/or the cumulated rank reject vector generate at least one output depending on the at least one consensuality parameter and/or on the at least one insensibility parameter.

The consensuality parameter allows to find the best output as a function of the primary objective. For example, the consensuality parameter can be set to 1 if the primary objective is to find a consensus as a result of the present invention. The insensitivity parameter allows to find ex-aequo candidate data objects.

Setting this parameter as a function of the primary objective is an additional way to obtain the best information regarding the objective of the evaluators.

According to one embodiment, the extracting step e) 600 is about the extraction of information based on the numbers of supports of each candidate data object. For example, one can consider only the candidate data object having the highest number of supports, meaning the one being the most supported.

According to one embodiment, the extracting step e) 600 is about the extraction of information based on the numbers of rejects of each candidate data object. For example, on can consider only the candidate data object having the lowest number of rejections, meaning the one being the less rejected.

According to one embodiment, the main parameters being involved in the output of the step e) 600 are the consensuality parameter and the insensitivity parameter. These two parameters can be fitted in order to optimize the output of the step e) 600 regarding the objective of the evaluators.

As shown previously, depending of the value of the consensuality parameter, the output can be a quantified majority output, an unanimity output, an utility output, an equity output, an optimum output, a multicriteria output.

According to one embodiment, the consensuality parameter defines a majority threshold.

This threshold can be a majority one and/or a minority one. Depending of the situation, this threshold is adapted to obtain the information that is the most efficient for the evaluators.

According to one embodiment, the consensuality is comprised between 0 and 1, and advantageously it is expressed as a percentage between 0% and 100%. According to one embodiment, this consensuality parameter is used as a filter applied over the cumulated rank support vector of each candidate and/or over the cumulated rank reject vector of each candidate. This filtering process makes the needed information linked to the primary objective of the evaluators.

According to one embodiment, depending on the value of the consensuality parameter, the extracted information can be different. This characteristic of the present invention allows to fit the output to the primary objective by playing with some parameters of the method such as the consensuality parameter and the insensitivity parameter.

According to one embodiment, the output is at least one output taken among the following outputs: a majority output including all the levels of the quantified majority, a unanimity output, a utility output, an equity output, an optimum output, and a multicriteria output.

If the consensuality parameter is set to any value between 0% and 100%, the output of the present method is a quantified majority output.

If the consensuality parameter is set to a value equal to 100%, the output of the present method is a unanimity output.

In the case where the output corresponds to the candidate data object that is the most supported, the output is called a utility output.

In the case where the output corresponds to the candidate data object that is the less rejected, the output is called an equity output.

In the case where the output corresponds to the candidate data object that is both the less rejected and the most supported in one ballot, the output is called an optimum output.

In the case where the output corresponds to the candidate data object which is the most supported, or to the candidate data object which is the less rejected, or to the candidate data object which is both the less rejected and the most supported compared to the sum of several ballots representing several primary objectives, the output is called a multicriteria output.

According to one embodiment, the insensitivity parameter defines an ex-aequo threshold allowing a filtering of the preference ballot, this parameter is set between 0% to 100%.

According to one embodiment, the extracting step e) 600 is about the confrontation between at least the primary objective and the said output in order to obtain information.

According to one embodiment, each evaluator has its own primary objective, in this situation, several output can be generated, each of them comprising information that can be similar and/or different for each evaluator.

According to a preferred embodiment, the primary objective is the same for all the evaluators.

The extracted information is then used in order to execute a set of actions. For example this information can be what voltage to apply to several sensors in order to increase their range of detection. The action is then sending a signal to each sensor in order to increase their operating voltage.

The present invention can, for example, be used in a multi-agent system environment. This kind of system comprises a number of more or less autonomous artificial entities, named agents, that interact more or less loosely, and more or less cooperatively, with the aim of achieving an objective. Most of the time, the agents are designed to achieve one precise objective which is, most of the time, common to all the agents.

Usually, in order to fulfil this objective, these agents need to reach agreements in order to work together. The present invention can then be used in order to reach this agreement.

For example each agent can be an evaluator, a candidate and/or data information. These different roles depend directly of the multi-agent system configuration.

For example, the present invention can be applied to a set of robots acting in a multi-agent system. Each robot is an agent considered as an evaluator in this example. The main objective that the robots have to achieve is to physically check several targets positioned in a predetermined area at different locations known by the robots.

In order to be effective, the group of robots needs to determine, for each robots, none, one or several targets to check. The set of parameters that have to be taken into account can comprise, for example, the number of targets, the size of each target, the position of each target, the number of robots, the position of each robot, the energy level of each robot, the size of each robot, the speed of each robot and the checking distance between a robot and a target (this distance is the maximum distance between a robot checking a target).

In this example each target has to be checked as quickly as possible by at least two different robots in order to perform the objective of the robots.

Then, for each robot, a trajectory has to be determined, this trajectory has to include none, one or several targets to check. This trajectory has to be determined in order to avoid the other robots unnecessary checks, in order to be closed enough of each target to be checked.

Then, each robot completes a preferential vote of the targets to be visited according to the said parameters and the said objective. The preferential vote is then processed by the present invention in order to determine the trajectory of each robot. One advantage of the present invention is also to be able to extract different trajectories based on only one preferential vote session. In fact, the utility procedure, the optimum procedure, the equity procedure can all be used alone or in a synergy in order to extract different trajectories based on the objective of the robots. For example, if one added obligation is to minimize the energy consumption of each robot, then the trajectory assigned to each robot can be different than in the case the energy loss is not taken into account.

In another example, to obtain accurate information on the climate prediction, it is possible to establish several data profiles that are able to consider and combine both data coming from at least one sensor placed throughout a said geographic area, data coming from the satellite observation, and data coming from mathematical computing systems. In such case, sensor, satellite observation, mathematical systems, and computer systems are producing three different candidate data objects. They are not acting as evaluators, but only for data retrieving. In such a configuration, it is necessary to create a group of independent evaluators which can be a set of computer programs for example. As evaluators can classify any types of data that correspond to the objective that has been set, it is therefore possible to develop a multi-dimensional approach in order to extract information from data of very different natures.

The present invention relates, for example, to a weather prediction system comprising a processor where operation of the processor in accordance with a computer program stored in a non-transitory computer-readable medium causes the computerized system to extract weather information corresponding to at least one weather candidate data object from weather candidate data objects contained in at least one weather database (100) being stored in at least one computerized storing device, and from parameters provided by evaluators and comprising evaluation criteria (10), comprising at least one processor configured to execute the following steps:
a) Retrieving (200) weather candidate data objects from the at least one weather database using the said evaluation criteria (10), the said at least one weather database containing a plurality of weather data of at least one predetermined geographical area given by at least one weather satellite looking after the said at least one geographical area, and at least one weather sensors, the said evaluators comprising weather computer programs;
b) Determining (300) a set of ranks each having a different preference level on a preference scale, wherein the ranks are sorted on the preference scale according to their
c) Determining (400), for each evaluator, a candidate rank assigned, among the set of ranks, to each of the retrieved weather candidate data objects;
d) For each weather candidate data object and each rank, processing (500) a number of supports as a function of a number of times the said candidate rank has been assigned by evaluators to said weather candidate data object and as a function of the evaluation criteria (10);

In another example, the extracted information can be a set of collective decision taken by a network of intelligent actors. As the actors can send all kinds of data allowed in the network, the process is able to aggregate all these data in a real time process in order to produce a set of collective decisions. The process is also able to assess the compatibility of the last set of decisions with the goals defined by the evaluators, and to compare the different sets of present decisions in order to produce relevant information and relevant criteria to increase the technical operations of the future set of decisions. This means that with a computer program of the process of this invention, the actors are able to evolve and to increase their performance, thanks to the extraction information process which has the capacity to function like a learning system.

In another example, the information can be the name of a person who has just been elected by a group of evaluators using the present invention. As the evaluators have to rank all the persons who are candidate, the result that they obtain with a preference pool is more exhaustive and more representative of the collective will than if they would just have been allowed to vote for one person in a uninominal pool. Thus, if this election is realized with a group of several millions of evaluators, a special system for processing all the information received by the evaluators is necessary, and this invention functions so as a treatment system of the big data generated by the ballot

In another example, the information can be a set of signals for a transport network in a smart city. In interaction with the multiple data collected in the smart city, one can optimize all the technologies used for the traffic regulation. For example, certain road lights may lengthen the duration of red or green lightening depending on the traffic level. Drivers may be informed in real time about the road condition (good or bad, dry or wet, bottlenecked or smooth flow of traffic) in order to be advised of a good driving speed. Drivers are informed in real time about free parking spaces when they are looking for a place in a saturated area of a city. This progressive regulation system can work with captors, cameras, and many data collected (like traffic statistics, weather previsions, drivers' notifications) and needs to identify permanently preferences and priorities in order to produce the best possible result in the big data processing.

In another example, the information can be the temperature of a building or a technical installation (like a data center) in order to increase or decrease the temperature of different rooms and produce the temperature corresponding to the purposes of the evaluators. The process enables a group of sensors or persons using this invention to define a dynamic system of temperature regulation, by taking into account and mixing a multiplicity of criteria decisions such as humidity, brightness, air movement, energy cost, weather context, level of activity, people needs, and any further parameter. This process is especially useful in the randomized systems where nobody has the entire data to take the collective decisions and where it is always necessary to retrieve new data to produce relevant information corresponding to the evaluators' purpose. In a sensitive environment, emergency procedures (like for fires, floods) that necessitate a constant coordination between actors and functions can be preconfigured with the process of the invention that is able to take many constraints into account to produce in real time the most relevant strategy.

In another example, the information can be a specific genetic data sequence searched in a huge genetic database where many data are incomplete or missing. The process of this invention enables evaluators to determine candidates' data profiles in order to process unstructured data and to aggregate them in the preference ranking system. The consensuality parameter of this invention allows evaluators to define a selection level that separates genetic sequences that are not relevant from those that have relevant content. The utility procedure allows evaluators to identify automatically genetic data that are the most interesting according to their goal or their utility. The equity procedure is useful for identifying automatically genetic sequences that are not interesting at all to achieve evaluator's purpose. The variation of the consensuality parameter makes possible to determine the force of the relevant signal that the evaluators want to take into account. A high level of consensuality parameter is useful to detect the weak signals and to evaluate if they are negative or not. The flexibility of the invention makes it evolve in relation to the programming of evaluators.

According to one embodiment, an evaluator can be any entity (real or virtual) such as a computer, a group of computers, software, a group of software, a person, a group of persons, any kind of entity being able to have a primary objective.

According to one embodiment, an evaluator can comprise a computer program stored on a non-transitory storage medium.

According to one embodiment, an evaluator comprises evaluation criteria and is able to operate data objects ordering.

In another example, it can be the rate of signal transmission over several nodes of a network, each node playing the role of an evaluator in order to optimize the traffic of signals all over the network.

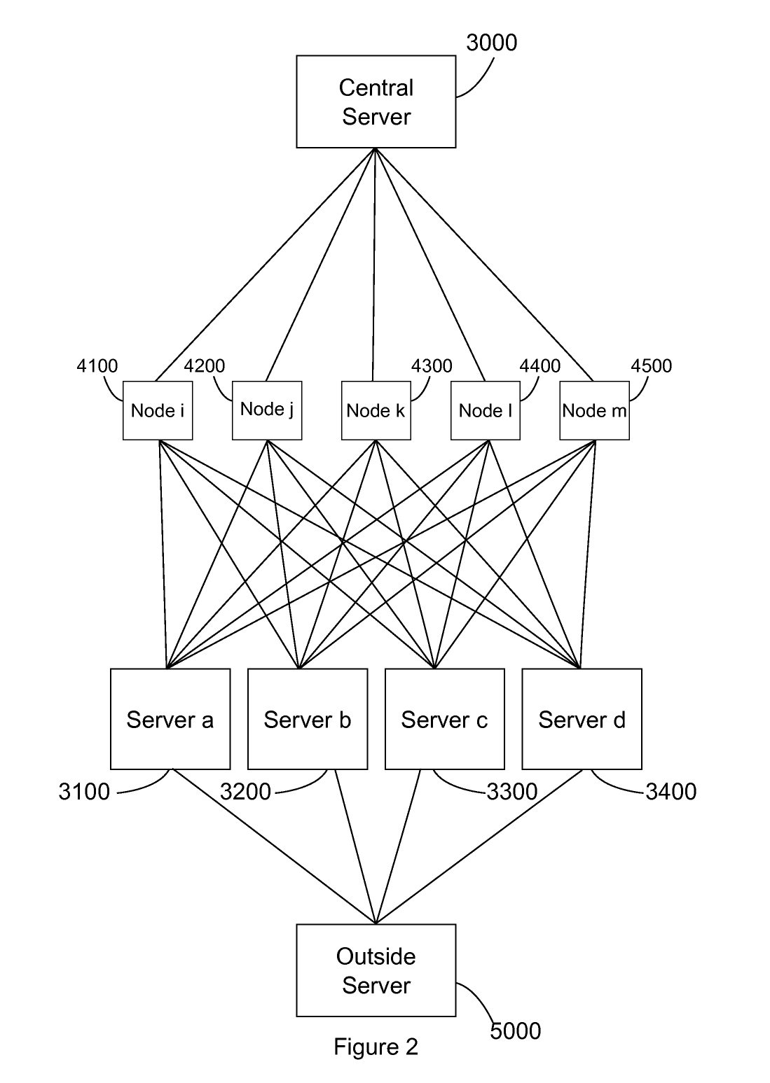

FIG. 2 depicts this previous example of use of the present invention in a computerized environment.

A central server 3000 comprises communications data and a database 100 containing data objects such as voltage values, current values, configuration parameters, names, addresses over the network, download rate values and upload rate values of several servers.

Several network nodes (4100, 4200, 4300, 4400, 4500) are connected to the central server 3000 and to several servers (3100, 3200, 3300, 3400) comprised in the list of servers.

The problematic in this system is to improve the upload rate of communication data between the central server and an outside server 5000 passing through one of the 4 servers (3100, 3200, 3300, 3400).

In order to optimize this upload rate, the five network nodes have to transfer communication data to one of the 4 servers depending on their own parameters, such as their upload rate.

In order to do that, the present invention is used. First, the names the servers are selected from the database 100 applying the step a) 200 of the present invention.

Then, a set of ranks is determined, using the step b) 300 of the present invention, wherein the ranks have a different preference level and are sorted on a preference scale according to their preference level. The number of ranks is equal to 5: one for each candidate data object and a last one, the default one.

A determination of a candidate rank assigned to each candidate data object is performed using the step c) 400 of the present invention. Each network node expresses its preference based on its own parameters such as its own upload rate for example.

Then the processing of the step d) 500 of the present invention is done. This process is about the number of times each candidate rank has been assigned to each server applying, if it is necessary, a consensuality parameter and/or an insensitivity parameter.

From this processing, information is extracted. This information is the name of the server to which the network nodes have to transfer communication data in order to optimize the upload rate of the full system. The extraction of this information is based on the consensuality parameter. For example it can be the first server reaching 100% of preference at a given rank.

This method is really fast to be executed allowing a real time switching server in order to optimize the upload rate of the communication data.

According to one embodiment, the present process first distinguishes, for each Voter i, the set of candidates that Voter i supports (Tᵢ) and the one that it does not support (⊥ᵢ). Then each evaluator provides some information about its supported candidates (i.e. the one that belong to Tᵢ) and that are used to express the ranks that Voter i would like them to obtain. The information from each Voter i ballot is computed in order to produce its vote, Voteᵢ which is the function that distinguishes supported and not supported candidates and assigns to each supported candidate a rank.

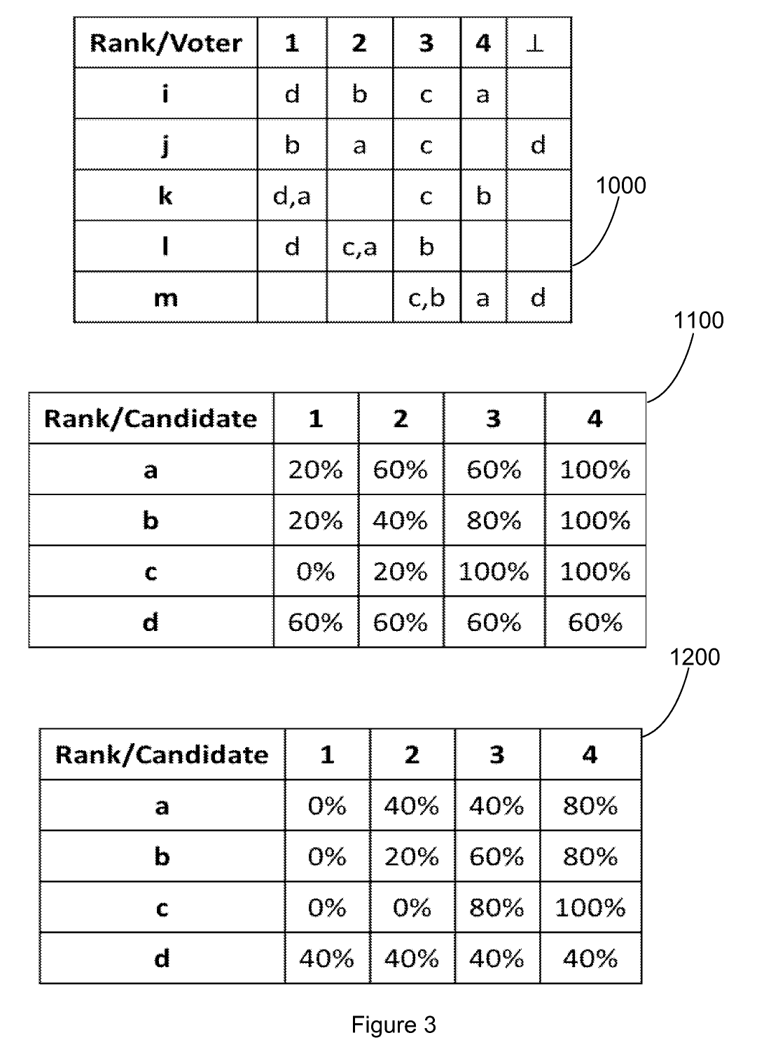

The table 1 of FIG. 3 illustrates, in a particular embodiment, the ranking {1, 2, 3 4, and ⊥} of 4 candidates {a, b, c, d} by 5 evaluators {i, j, k, l and m}.

According to one embodiment, table 2 of FIG. 3 illustrates the cumulated rank support vectors.

Candidate a, for example, has been ranked to the rank 1, one time only, that means that over 5 evaluators, only one has preferred Candidate a to be at the rank 1, the best rank. That means that Candidate a has a support equal to 20% for the rank 1. Considering the rank 2, Candidate a has been ranked twice at this rank. That means that Candidate a has a support at rank 2 equal to 40% but since it is a cumulated vector, one has to add the first 20% of the rank 1, that means that Candidate a has a cumulated rank supported vectors equal to 60% for the rank 2. Then with the same process, the rank 3 has a value equal to 60% for the Candidate a because none of the evaluators has ranked Candidate a on the third rank. For the last rank, the rank 4, Candidate a has 100% for the same reason has above (60%+40%).

Regarding Candidate d, the evaluators j and m have not ranked it at all, which means that the cumulated rank support vector of Candidate d doesn't reach 100% at the rank 4 (the last one).

Turning to table 2, regarding the evaluators' parameters, there are several possible outputs. This output (i.e. the extracted information returned by the invention) here corresponds to the identification of an elected candidate.

In the context of the quantified majority, if the consensuality parameter is set to, for example, 30%, Candidate d is the first one to reach a value higher than the consensuality parameter; then Candidate d is chosen.

In the context of the absolute majority, if the consensuality parameter is set to 51%, Candidate d is again the first one to reach a value higher than the consensuality parameter, then Candidate d is chosen.

In the context of the utility, if the consensuality parameter is set to 0%, Candidate d is the first one to reach a value higher than the consensuality parameter, then the Candidate d is chosen.

That means than for three of the previous analyses, Candidate d is the preferred choice. Now considering the unanimity output, which means the consensuality parameter equal to 100%, the Candidate d is not the preferred one; the latter is Candidate c, the one that all evaluators preferred; it is the choice that leads to an unanimity.

Concerning the cumulated rank reject vector, the application of the definition explains table 3 of FIG. 3. For instance, Candidate a has 0% for the rank 1 because none of the evaluators have ranked Candidate a. But it is not the case for Candidate d for two evaluators (j and m) have not ranked Candidate d; thus Candidate d has a rejection level equal to 40% for the rank 1.

In this situation, applying an equity analysis, which means considering the highest percentage at the last rank, defines Candidate c as the preferred one for an equity choice.

According to one embodiment, the present invention allows a group of evaluators to determine and extract information from a set of data contained in a database grounding the extraction on evaluation criteria and preferential filters. In the previous example, the data are {a, b, c, d} and the information is the preferred candidate based on several parameters and as shown previously, the output depends directly from the kind of analysis which is applied. In only one session of preference expression by evaluators, the process can determine several outputs corresponding to several cases of evaluation criteria in order to be able to propose the most relevant information to the group of evaluators.

According to one embodiment, the preferential parameters are used by each evaluator in order to rank each candidate. These parameters can be common to all the evaluators and/or can be at least partially different for at least two evaluators. These preferential parameters can contain several data such as some primary objectives, some secondary objectives. These parameters are directly used in order to realize the ballot when they are applied to the organization of the candidates.

According to another embodiment, the evaluation criteria are used in order to decide the outputs to consider. These criteria can contain for example the consensuality parameter as well as the insensitivity parameter.

In one embodiment, these evaluation criteria are common to all the evaluators.

In one embodiment, each evaluator has its own evaluation criteria. In this situation, each evaluator can analyze the ballot differently or a ballot can be made in order to process and extract information from these different evaluation criteria in order to extract the best evaluation criterion to extract the information from the candidates. That means that original and common evaluation criteria must already exist in a sub level for all the evaluators in order to be able to decide which evaluation criteria is used for the candidates from the database.

As explained before, the candidates are data which can be any kind of data. For example, it can be the value of an upload rate over a computerized communication network, each evaluator being a node of the network needing to optimize the upload rate. Each node ranks the candidates and then for example, a consensuality parameter set to 100% is used as valuation criterion in order to optimize each node, then the present invention allows for an extraction of the best value of the upload rate corresponding to an optimization of each of the node, a consensus.

In one embodiment, a first level of analysis takes the evaluation criteria of each evaluator as a candidate. In this situation, native evaluation criteria are used to determine the optimized evaluation criterion to use.

According to one embodiment of the present invention, a social ordering is obtained by comparing the candidates support vector or the candidates reject vector. In the first case, the analysis focuses on preferring the candidates that are the most supported, the second case focuses on preferring the candidates that are the less rejected. Both these processes rely to the lexicographic ordering. The lexicographic order is an order over a vector of element that depends on an order over those elements. As an example, when the elements are letters (the vector being a word, it is thus called the alphabetical order).

According to an embodiment, an example of social ordering computation based on the present invention is given hereafter. Still working with the vote profile of the example one (see the table 2 of FIG. 3) Candidate d is the first to reach the highest support at cumulated rank 1. It is thus ranked first. Whereas Candidate c is the only one not selected as a first preference by any evaluator; it is thus ranked last, if one consider only the first rank. Candidate a and Candidate b are ex-aequo in the first rank, but Candidate a is preferred at the second cumulated rank. The resulting social order in term of support is thus:

d [symbol] a [symbol] b [symbol] c

This resulting social order is called the support maximization.

Now considering the table 3 of FIG. 3 of the cumulated rank reject vectors, Candidate d is the only one that is not supported by some of the evaluators. It is thus ranked last. Candidates a, b and c are ex-aequo in the first cumulated rank, but not in the second cumulated rank. The resulting social order in term f rejection is thus:

c [symbol] b [symbol] a [symbol] d

This resulting social order is called the reject minimization.

As presented in the example, several interpretations can be made based on the same ballot in order to extract different information as a function of the evaluators' parameters.

According to one embodiment, the present invention comprises two main parameters in order to improve the legitimacy of the information extracted from the ballot. One can note

$$≻ \begin{matrix}support \\ ( ∇ , ε )\end{matrix} , ≻ \begin{matrix}reject \\ ( ∇ , ε )\end{matrix}$$

the social preference relations with those parameters, where ∇ is the parameter named consensuality and ε the one named insensitivity.

According to one embodiment, the consensuality parameter is part of the evaluators' parameters and is configured in order to consider only robust information that has been consensually agreed by a sufficiently high percentage of the evaluators.

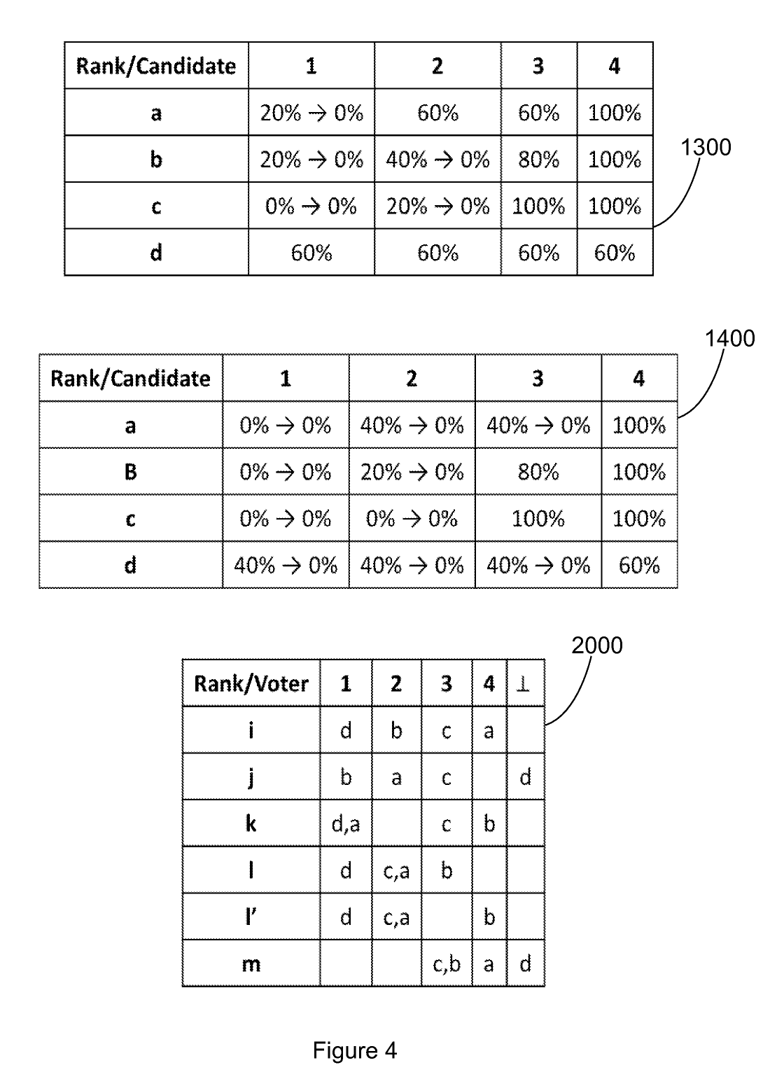

For example, let's consider the ballot of table 1 of FIG. 3, and take a consensuality parameter equal to 55% into account. This means that all support or rejection that is not agreed by less than 55% of the evaluators is not taken into account. Then the cumulated rank vector is given by table 4 of FIG. 4 when the consensuality parameter is applied. In this table 4 of FIG. 4, Candidate d reaches the soonest the highest support based at rank1; it is thus ranked first. Whereas none of Candidates a, b and c is the first preference of any decisive subset of any evaluator at the first cumulated rank; they are ex-aequo. At the second cumulated rank, Candidate a is the only one of the remaining to have reached the required consensuality, it is ranked second and the other are still ex-aequo. The third cumulated rank allows to discriminate the Candidates b and c. The resulting social order in term of support is thus:

$$d ≻ \begin{matrix}support \\ ( 0.55 , 0 )\end{matrix} a ≻ \begin{matrix}support \\ ( 0.55 , 0 )\end{matrix} c ≻ \begin{matrix}support \\ ( 0.55 , 0 )\end{matrix} b \\$$

The same way as the previous examples, table 5 of FIG. 4 illustrates the cumulated rank reject vector based on the application of the consensuality. In this situation, one needs to go up to the third cumulated rank to discriminate the candidates. Candidate b reaches the first place, followed by Candidate c, Candidate a and Candidate d being ex-aequo. The last rank exhibits a lesser rejection for Candidate d than for Candidate a. The resulting social order in term of rejection is thus:

$$b ≻ \begin{matrix}reject \\ ( 0.55 , 0 )\end{matrix} c ≻ \begin{matrix}reject \\ ( 0.55 , 0 )\end{matrix} d ≻ \begin{matrix}reject \\ ( 0.55 , 0 )\end{matrix} a$$

According to an embodiment, the insensitivity parameter is part of the evaluators' parameters and is configured in order to identify the candidates that have succeeded in making a difference with their competitors. For example, taking again the ballot of table 1 of FIG. 3 and considering an insensitivity parameter equal to 33%, the application of this parameter over this ballot means that, for a candidate not to be ex-aequo with another, it requires a support (respectively a rejection) higher (respectively lower) than a third of the candidates. In this example, Candidate d is noticeably higher, at the first cumulated rank, than the others. The second cumulated rank also allows to discriminate some candidates: Candidate a is noticeably more supported than Candidate c. Candidate b support is close to both supports of Candidate a and Candidate c, and that it is true at every rank. Thus it can be expressed by the following relations:

$$d ≻ \begin{matrix}support \\ ( 0 , 0.33 )\end{matrix} \{ a , b , c \}$$

$$a ≻ \begin{matrix}support \\ ( 0 , 0.33 )\end{matrix} c$$

$$b \sim \begin{matrix}Support \\ ( 0 , 0.33 )\end{matrix} a and b \sim \begin{matrix}Support \\ ( 0 , 0.33 )\end{matrix} c$$

This relation means that if the evaluation criteria lead to choose between Candidate a, b, c and d, then d is clearly more supported. Similarly, if the choice is between Candidate a and c, Candidate a is the best. However, there is no difference to choose a or b, or, c orb, if the choice is restricted to one of this couple.

According to an embodiment, the insensitivity parameter increases the number of ex-aequo, and this emphasizes the differences between candidates when these differences are higher than the insensitivity parameter, otherwise the differences disappear.

Table 6 of FIG. 4 depicts the expression of individual preferences as ordinal ballot using the strict ordinal ballot and the weak ordinal ballot according to an embodiment of the present invention.

Using table 6 of FIG. 4, each evaluator has ranked each candidate. The strict ordinal formalism for the evaluator i for example is the same than the weak ordinal formalism:

d>ᵢb>ᵢc>ᵢa

The evaluator j expresses preferences about its supported candidates, Candidate a, b and c and in this example it does not support Candidate d at all. This can be expressed by the strict ordinal formalism and the weak ordinal formalism in the same way:

b>ⱼa>ⱼc

The evaluator k preferences can not be expressed by the strict ordinal formalism, because there is a tie between Candidate a and Candidate d, and then a rank which is not the last one is not associated with a candidate. Thus only the weak formalism can be used to express the preferences of the evaluator:

a≡ₖd>ₖc>ₖb

Concerning the evaluators I and I′, they express a support for Candidate d and that Candidate a and Candidate c are equivalent. However both are preferred to Candidate b. The slight difference between the rating ballot of I and I′ has an impact on the social extracted information. The preferences of I and I′ can only be expressed using the weak ordinal formalism:

d>ₗa≡ₗc>ₗb

d>ₗ, a≡ₗ, c>ₗ, b

The previous considerations depict the ability of the present invention to formalize a technical problem in a way allowing for a process of the data in a new manner with extraction of several information about technical issue as well as social ones. Within only one process, it is possible for several evaluators being real or virtual, humans or programs, to express their preference regarding their objectives. It is thus possible to find new solutions for already existing problems, said solutions being optimized compared to the existing ones.

The foregoing description has provided by way of exemplary and non-limiting examples a full and informative description of various method, apparatus and computer program software for implementing the exemplary embodiments of this invention. However, various modifications and adaptations may become apparent to those skilled in the relevant arts in view of the foregoing description, when read in conjunction with the accompanying drawings and the appended claims.

The use of other similar or equivalent modifications may be attempted by those skilled in the art. However, all such and similar modifications of the teachings of this invention will still fall within the scope of the embodiments of this invention. Furthermore, some of the features of the exemplary embodiments of this invention may be used to advantage without the corresponding use of other features. As such, the foregoing description should be considered as merely illustrative of the principles, teachings and embodiments of this invention, and not in limitation thereof.

The present invention is not limited to the embodiments described in the foregoing but extends to any embodiment in conformity with the claims.

What is claimed:

1. A method of extraction of information corresponding to at least one candidate data object among a plurality of candidate data objects contained in at least one database being stored in at least one computerized storing device, and from parameters provided by evaluators and comprising evaluation criteria, the method being executed by at least one processor and comprising the following steps:
a) Retrieving the plurality of candidate data objects from the at least one database using the said evaluation criteria;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved candidate data objects;
d) For each candidate data object and each rank, processing a number of supports as a function of a number of times the said candidate rank has been assigned by evaluators to said candidate data object and as a function of the evaluation criteria;
e) Extracting said information based on the numbers of supports and generating at least one output comprising said information.

2. The method of claim 1, wherein the processing step d) comprises a cumulated process adding, for each candidate data object and for each rank, the number of supports, divided by a total number of evaluators, of any rank having a preference level higher than that of said each rank to the number of supports of the said each rank, divided by the total number of evaluators, thereby generating a cumulated rank support value for each rank for each candidate data object and, determining a cumulated rank support vector comprising at least one of the cumulated rank support values for each candidate data object.

3. The method of the claim 2, wherein the cumulated rank support vector of a candidate data object comprises for each rank a percentage of evaluators supporting the said candidate data object at said rank, cumulated with a percentage of evaluators supporting the said candidate data object at any ranks having a preference level higher than that of the said rank.

4. The method of claim 1, wherein the processing step d) comprises a cumulated process generating a cumulated rank reject value for each rank and for each candidate data object and a cumulated rank reject vector for each candidate data object comprising at least one of the cumulated rank reject values, the cumulated rank reject value being for any given rank n, among the set of ranks, a number of evaluators, divided by a total number of evaluators, which rank the candidate data object in a rank having the last-but-(n−1) lowest preference level, cumulated with the cumulated rank reject value at an adjacent rank having a preference level higher than that of the given rank n.

5. The method of claim 4, wherein the step d) comprises a cumulated process adding, for each candidate data object and for each rank, the number of supports, divided by a total number of evaluators, of any rank having a preference level higher than that of said each rank to the number of supports of the said each rank, divided by the total number of evaluators, thereby generating a cumulated rank support value for each rank for each candidate data object and, determining a cumulated rank support vector comprising at least one of the cumulated rank support values for each candidate data object.

6. The method of claim 1, wherein the number of ranks is equal to the number of retrieved candidate data objects plus one, a last rank being called default rank and corresponding to a rank having a lowest preference level, the method comprising assigning the default rank to a candidate data object each time no data has been received from an evaluator for said candidate data object.

7. The method of claim 1, wherein the evaluation criteria contain at least a candidate data object profile in order to retrieve the candidate data objects from the at least one database.

8. The method of claim 1, wherein the evaluation criteria contain at least a consensuality parameter defining a majority threshold that is comprised between 0 and 1.

9. The method of claim 1, wherein the evaluation criteria contain at least an insensitivity parameter defining an ex-aequo threshold that is comprised between 0 and 1.

10. The method of claim 1, wherein the evaluation criteria contain at least a primary objective.

11. The method of claim 1, wherein the evaluation criteria contain at most several primary objectives defining a multicriteria ballot.

12. The method of claim 1, wherein the evaluation criteria are common to all the evaluators.

13. The method of claim 1, wherein the evaluation criteria are common to at least some of the evaluators.

14. The method of claim 1, wherein the evaluation criteria of at least two evaluators are different.

15. The method of claim 5, wherein the cumulated rank support vectors and/or the cumulated rank reject vectors generate the at least one output depending on the at least one consensuality parameter defining a threshold that is comprised between 0 and 1.

16. The method of claim 14, wherein the at least one consensuality parameter defines a majority threshold.

17. The method of claim 14, wherein the at least one consensuality parameter defines a minority threshold.

18. The method of claim 5, wherein the cumulated rank support vectors and/or the cumulated rank reject vectors generate the at least one output depending on the at least one insensibility parameter defining an ex-aequo threshold that is comprised between 0 and 1.

19. The method of claim 14, wherein the at least one output is at least one output taken among the following outputs: a quantified majority output, a unanimity output, a utility output, an equity output, an optimum output, a multicriteria output.

20. Computer program product stored on a non-transitory computer-readable medium and comprising instructions adapted to perform the method of any of the preceding claims when execute by at least one processor.

21. An information extracting computerized system comprising at least one processor where operation of the said at least one processor in accordance with at least one computer program stored in at least one non-transitory computer-readable medium causes the computerized system to extract information corresponding to at least one candidate data object from candidate data objects contained in at least one database being stored in at least one computerized storing device, and from parameters provided by evaluators and comprising evaluation criteria, comprising at least one processor configured to execute the following steps:
a) Retrieving candidate data objects from the at least one database using the said evaluation criteria;
b) Determining a set of ranks each having a different preference level on a preference scale, wherein the ranks are sorted on the preference scale according to their preference levels;
c) Determining, for each evaluator, a candidate rank assigned, among the set of ranks, to each of the retrieved candidate data objects;
d) For each candidate data object and each rank, processing a number of supports as a function of a number of times the said candidate rank has been assigned by evaluators to said candidate data object and as a function of the evaluation criteria;
e) Extracting said information based on the numbers of supports generating at least one output.

22. The information extracting computerized system of claim 21, wherein each evaluator is at least one entity taken among: sensor, network node, human being, computer program.

23. The information extracting computerized system of claim 21, wherein the extracted information is a weather prediction concerning at least one geographical area, wherein the at least one database is a weather database comprising weather candidate data objects provided by at least one satellite looking after the at least one geographical area and by at least one weather sensor, and wherein the evaluators comprise at least one weather computer program in order to predict the weather of the at least one geographical area.

24. The information extracting computerized system of claim 21, wherein the extracted information is the name of a person which is elected by a group of evaluators, wherein the candidate data objects are the name of each candidate to the election provided by at least one list of candidates' names, and wherein the group of evaluators comprises at least two persons.

25. The information extracting computerized system of claim 21, wherein the extracted information is a set of signals for transport network, wherein the candidate data objects are data collected by sensors inside the transport network, and wherein the evaluators comprise at least one traffic optimization computer program in order to improve the smoothness of the traffic.

26. The information extracting computerized system of claim 21, wherein the extracted information is a set of environmental parameters of a building in order to reduce its energy cost, wherein the candidate data objects are data collected by sensors inside the building, and wherein the evaluators comprise at least a group of person living inside the building.

27. The information extracting computerized system of claim 21, wherein the extracted information is a specific genetic data sequence, wherein the candidate data objects are unstructured genetic data contained inside a genetic database, and wherein the evaluators comprise at least one restructuring genetic data computer program configured in order to restructure the specific genetic data sequence.

28. The extracting information computerized system of claim 21 wherein, the extracted information is a set of trajectories of a set of robots, wherein the candidate data objects are targets contained in a targets database comprising several parameters regarding features of targets and robots, and wherein the evaluators are the said robots and each comprise at least one program configured to evaluate a trajectory to follow to reach the said targets.
